(19) United States
(12) Patent Application Publication
(10) Pub. No.: US 2026/0188099 A1
(43) Pub. Date: Jul. 2, 2026

(54) Temporally Distributed Transmission of Incident Data Records Logged by a Fire Alarm and Including Measurement Values Relating to Significant Fire Characteristic Variables to a Central Fire Alarm System

(71) Applicant: Siemens Schweiz AG, Zürich (CH)

(72) Inventor: Ulrich Kuhn-Matysiak, Staufen (DE)

(73) Assignee: Siemens Schweiz AG, Zürich (CH)

(21) Appl. No.: 18/859,460

(22) PCT Filed: Apr. 28, 2022
(86) PCT No.: PCT/EP2022/061394

§ 371 Date: Oct. 23, 2024

(51) Int. Cl. G08B 25/00

(52) U.S. Cl. CPC G08B 25/007; G08B 25/001; G08B 25/002

(57) ABSTRACT

Some embodiments of the teachings herein include a method for recording measurement values relating to a fire characteristic variable indicating a potential fire incident and detected by a fire alarm device. An example includes: supplying energy to a central fire alarm system with a plurality of fire alarm devices connected via a common detector line for data transmission purposes; temporarily storing measurement values, if a current measurement value exceeds a threshold value indicating a potential fire incident, as a log recorded in a data memory of the respective fire alarm device; forming an incident data record upon completion of the recording from the respective measurement values together with header data; and transferring an incident data record by the respective fire alarm device in a temporally distributed manner and using multiple data transmission blocks released by the central fire alarm system to the central fire alarm system.

### CROSS-REFERENCE TO RELATED APPLICATIONS

This application is a U.S. National Stage Application of International Application No. PCT/EP2022/061394 filed Apr. 28, 2022, which designates the United States of America, the contents of which are hereby incorporated by reference in their entirety.

### TECHNICAL FIELD

The present disclosure relates to fire alarms. Various embodiments of the teachings herein include systems and/or methods for recording measurement values, in particular raw measurement values, relating to at least one significant fire characteristic variable indicating a potential fire incident and detected by a fire alarm device.

### BACKGROUND

U.S. Pat. No. 8,299,911 B2 describes a testing device for hazard alarm systems, in particular for fire alarm systems, having a hazard alarm control center which is connected to a plurality of subscribers via at least one subscriber loop embodied as a ring bus system and having at least one communication circuit for communication with the individual subscribers. In this arrangement, the communication circuit comprises multiple functional units. A current measurement unit is tested and monitored herein by a subscriber simulation unit. The subscriber simulation unit is preferably fully integrated into the communication circuit and is controlled by means of a control unit that is preferably embodied as a microcontroller. Also disclosed is a testing and monitoring method of the current measurement unit of the communication circuit using the subscriber simulation unit.

A network distribution system using communication and power comprising a power line, multiple fire alarm units and a power line control device is described in US 2022/068115 A1. The power line provides alternating current and the fire alarm units are coupled to the power line. The control device for the power line is connected to the power line and to a specific fire alarm unit from the plurality of fire alarm units. The control device for the power grid comprises a communications translator for converting between power grid and non-power grid protocols and a power grid core for modulating signals onto the power grid and for demodulating signals from the power grid.

“Raw measurement values” indicates unprocessed measurement values which an analog/digital converter converts from a metrologically acquired analog fire characteristic variable into a digital measurement value. They can therefore be referred to also as raw data.

Fire characteristic variables may include the smoke density, the temperature and the concentration of combustion gases such as carbon monoxide (CO) and carbon dioxide (CO₂) in the vicinity of a fire alarm device. The smoke density is usually measured by means of an optical photosensor, such as e.g. by means of a photodiode. The photosensor is typically disposed in a scattered light arrangement to form a light emitter (LED) and provides a corresponding optical scattered light signal on the output side.

Alternatively, the photosensor may be disposed in a transmitted light arrangement to form a light emitter (LED). In this case the photosensor provides a corresponding optical extinguishing signal on the output side. It is also possible to sense two optical scattered light signals, such as e.g. in a first wavelength range of 850 nm to 960 nm (infrared) and in a second wavelength range of 380 nm to 490 nm (blue or ultraviolet). Alternatively or in addition, two optical scattered light signals may also be sensed at different scattering angles, such as e.g. at a forward and backward scattering angle.

The temperature is typically measured by means of a temperature sensor, e.g. by means of one or more NTCs. The temperature sensor provides a corresponding (analog) temperature signal on the output side.

The concentration of combustion gases, in particular of carbon monoxide (CO) and carbon dioxide (CO₂), is measured by means of a CO and CO₂ sensor, respectively, and output on the output side as a CO or CO₂ concentration value or as a CO or CO₂ concentration level. A CO concentration is typically detected by means of an electrolytic gas sensor. Alternatively, semiconductor sensors, such as e.g. devices known as GASFETs, can be used.

Marked signal fluctuations or signal variations can in this case be indicative of an imminent actual fire or of a false alarm, but also merely of a state deviating slightly from the “normal state”.

### SUMMARY

The teachings of the present disclosure relate to a fire alarm device, in particular a smoke detector. For example, some embodiments include a method for recording measurement values (MOP, MT, MCO), in particular raw measurement values, relating to at least one significant fire characteristic variable (OPT, TEMP, CO) indicating a potential fire incident and detected by a fire alarm device (2), wherein a central fire alarm system (1) together with a plurality of fire alarm devices (2) of said type is connected via a common detector line (ML) to the fire alarm devices (2) in order to supply energy to the fire alarm device (2) and for data transmission purposes, wherein, if a current measurement value (MOP, MT, MCO) of the at least one fire characteristic variable (OPT, TEMP, CO) exceeds a respective predefined first threshold value (OG, TG, COG) as an indicator of a potential fire incident, measurement values (MOP, MT, MCO) are temporarily stored as a log recorded in a data memory (DS) of the respective fire alarm device (2), wherein, on completion of the recording, an incident data record (REC) is formed from the respective measurement values (MOP, MT, MCO) together with header data (HEADER), and wherein an incident data record (REC) is transferred by the respective fire alarm device (2) in a temporally distributed manner and by way of multiple data transmission blocks (DAT) released by the central fire alarm system (1) to the central fire alarm system (1), in particular at a lower priority.

In some embodiments, an average data transmission rate DRZ between a fire alarm device (2) and the central fire alarm system (1) is in particular less by a multiple than an average storage data rate DRM for storing an incident data record (REC) in the respective fire alarm device (2).

In some embodiments, the header data (HEADER) comprises file organization data (FILE) and/or a detector ID (ID) and/or a recording time (TIME) and/or a recording format (AF) or a detector type (TYPE), and possibly detector-side supplementary information (DL, AL) relating to a detector event, wherein a detector event is an alarm level (DL) generated independently by the respective fire alarm device (2), a fire alarm (AL) or a pre-alert.

In some embodiments, the data transmission between a fire alarm device (2) and the central fire alarm system (1) is performed in circulation cycles (CYC) with sequentially succeeding transmission frames (FRAME) for each fire alarm device (2), wherein a data transmission block (DAT) releasable by the central fire alarm system (1) is provided in each case in a transmission frame (FRAME) for the data transmission from the respective fire alarm device (2) to the central fire alarm system (1), and wherein a data transmission block (DAT) comprises a data volume in a range of 8 bits to 96 bits.

In some embodiments, the maximum data transmission rate DRZ amounts to 10 kbps, in particular 2 kbps, or 1 kbps.

In some embodiments, the measurement values (MOP, MT, MCO) of the at least one fire characteristic variable (OPT, TEMP, CO) are acquired at a higher sampling rate and stored in the data memory (DS) of the respective fire alarm device (2) if one of the respective predefined first threshold values (OG, TG, COG) has been exceeded.

In some embodiments, a respective incident data record (REC), in particular its header data (HEADER), received by the central fire alarm system (1) is extended by at least one piece of supplementary information (ZI; ZTIME, ZAL, MCP, Y/N) acquired by the central fire alarm system (1) and temporally assignable to the respective incident data record (REC) on the central system side, wherein supplementary information (ZI) on the central system side comprises a system time (ZTIME) of the central fire alarm system (1) and/or a fire alarm (AL) detected on the central system side and/or an alarm level (DL) detected on the central system side and/or a manual call point alarm (MCP) and/or a user-side input (Y/N) concerning the presence of an actual fire or of a false alarm, wherein the thus extended incident data record (REC+) is stored in a database (DB) of the central fire alarm system (1) or in a database (DB) of a cloud infrastructure (CLOUD) connected for data communication purposes to the central fire alarm system (1) to allow further possible, where appropriate partly automated, assessment of the extended incident data records (REC+) by a user in respect of the presence of an actual fire.

In some embodiments, the continuous acquisition of the measurement values (MOP, MT, MCO) of the at least one fire characteristic variable (OPT, TEMP, CO) in the respective fire alarm device (2) is terminated if a predefined acquisition time (T) for a respective incident data record (REC) is reached, or if the free storage capacity of the data memory (DS) has been exhausted, or if a fire alarm (AL) or an alarm level (DL) is generated by the respective fire alarm device (2), or if a respective predefined second threshold value (OG2, TG2, CG2) is exceeded which is greater than the associated respective first threshold value (OG, TG, CG), or if the respective predefined first threshold value (OG, TG, CG) is undershot once more, or if a STOP command from the common detector line (ML) in order to terminate the continuous acquisition is received by the respective fire alarm device (2).

In some embodiments, a respective formed incident data record (REC) for buffering is initially stored sequentially in a buffer (BUF) organized in the data memory (DS) of the respective fire alarm device (2), and wherein the incident data records (REC, REC1-RECn) stored in the buffer (BUF) of the respective fire alarm device (2) are then transmitted sequentially in the released transmission time blocks from the respective fire alarm device (2) to the central fire alarm system (1).

In some embodiments, after an incident data record (REC) has been stored in the buffer (BUF) of a respective fire alarm device (2), measurement values (MOP, MT, MCO) are again acquired continuously and stored if at least one respective measurement value (MOP, MT, MCO) once again exceeds the respective predefined first threshold value (OG, TG, CG) as an indicator of a potential fire incident.

In some embodiments, the measurement values (MOP, MT, MCO) of the at least one fire characteristic variable (OPT, TEMP, CO) are acquired continuously by the respective fire alarm device (2) and stored in a ring buffer (RING) organized in the data memory (DS) of the respective fire alarm device (2) and having a predefinable circulation time (UZ), wherein the measurement values (MOP, MT, MCO) stored in the ring buffer (RING) are saved as historical measurement values (HIST) in the data memory (DS) of the respective fire alarm device (2) by data processing means if at least one respective measurement value (MOP, MT, MCO) of the at least one fire characteristic variable (OPT, TEMP, CO) exceeds a respective predefined first threshold value (OG, TG, COG) as an indicator of a potential fire incident, wherein the measurement values (MOP, MT, MCO) of the at least one fire characteristic variable (OPT, TEMP, CO) are further acquired continuously by the respective fire alarm device (2), in particular further continuously in a seamless manner, and stored, and wherein the respective incident data record (REC) is then formed from the saved historical measurement values (HIST), from the further continuously acquired measurement values (MOP, MT, MCO) stored in the ring buffer (RING) and from the header data (HEADER).

In some embodiments, the measurement values (MOP, MT, MCO) of the at least one fire characteristic variable (OPT, TEMP, CO) are reduced in their data volume by means of a lossless or by means of a minimally lossy data reduction method.

As another example, some embodiments include a fire alarm device comprising at least one fire sensor (BS) for detecting a respective fire characteristic variable (OPT, TEMP, CO), a data memory (DS) and a control unit connected thereto, wherein the control unit is configured to acquire measurement values (MOP, MT, MCO) of at least one respective fire characteristic variable (OPT, TEMP, CO) and to output a fire alarm (AL) in the event of a fire being detected, and wherein the control unit is additionally configured to store continuously acquired measurement values (MOP, MT, MCO) of at least one respective fire characteristic variable (OPT, TEMP, CO) temporarily in the data memory (DS) if at least one respective measurement value (MOP, MT, MCO) of the at least one fire characteristic variable (OPT, TEMP, CO) exceeds a respective predefined first threshold value (OG, TG, COG), characterized in that the fire alarm device (2) is configured for operation on a common detector line (ML) with a central fire alarm system (1) for supplying electrical energy to the fire alarm device (2), for outputting the fire alarm (AL) and for transferring data to the central fire alarm system (1), and the control unit is configured to form an incident data record (REC) from the measurement values (MOP, MT, MCO) logged in the data memory (DS) of the fire alarm device (2) together with header data (HEADER) and to transfer the incident data record (REC) by way of data transmission blocks (DAT) released by the central fire alarm system (1) in a temporally distributed manner to the central fire alarm system (1), in particular at a lower priority.

In some embodiments, the fire alarm device (2) is configured to store a respective incident data record (REC) at an average storage data rate DRM in the data memory (DS) of the fire alarm device (2), wherein the average data transmission rate DRZ between the fire alarm device (2) and the central fire alarm system (1) is in particular less by a multiple than the average storage data rate DRM.

In some embodiments, the header data (HEADER) comprises file organization data (FILE) and/or a detector ID (ID) and/or a recording time (TIME) and/or a recording format (AF) or a detector type (TYPE), and possibly detector-side supplementary information (DL, AL) relating to a detector event, wherein a detector event is an alarm level (DL) generated independently by the fire alarm device (2), a fire alarm (AL) or a pre-alert.

In some embodiments, the control unit is configured to transmit the incident data record (REC) to the central fire alarm system (1) by way of multiple temporally distributed data transmission blocks (DAT) temporally allocated to the fire alarm device (2) and released by the central fire alarm system (1), and wherein a data transmission block (DAT) comprises a data volume in a range of 8 bits to 96 bits.

In some embodiments, the control unit is configured to acquire the measurement values (MOP, MT, MCO) of the at least one fire characteristic variable (OPT, TEMP, CO) at a higher sampling rate, in particular at twice or four times the sampling rate, after one of the respective predefined first threshold values (OG, TG, COG) has been exceeded.

In some embodiments, the control unit is configured to terminate the continuous acquisition of the measurement values (OP, MT, MCO) of the at least one fire characteristic variable (OPT, TEMP, CO) in the fire alarm device (2) if a predefined acquisition time (T) for the incident data record (REC) is reached, or if the free storage capacity of the data memory (DS) has been exhausted, or if a fire alarm (AL) or an alarm level (DL) is generated by the control unit, or if the respective predefined second threshold value (OG2, TG2, CG2), which is greater than the associated respective first threshold value (OG, TG, CG), is exceeded, or if the respective predefined first threshold value (OG, TG, CG) is undershot once more, or if a STOP command is received by the control unit from the—common detector line (ML) in order to terminate the continuous acquisition.

In some embodiments, the fire alarm device (2) comprises a buffer (BUF) organized in the data memory (DS) of the fire alarm device (2), wherein the control unit is configured to temporarily store a respectively formed incident data record (REC) initially sequentially for buffering in the buffer (BUF), and wherein the control unit is further configured to then transfer the buffered incident data records (REC; REC1-RECn) Sequentially in the released data transmission blocks (DAT) to the central fire alarm system (1).

In some embodiments, the fire alarm device (2) comprises a ring buffer (RING) organized in the data memory (DS) of the fire alarm device (2) and having a predefinable circulation time (UZ), and wherein the control unit is configured to acquire the measurement values (MOP, MT, MCO) of the at least one fire characteristic variable (OPT, TEMP, CO) continuously and to store them in the ring buffer (RING), to save the measurement values (MOP, MT, MCO) stored in the ring buffer (RING) as historical measurement values (HIST) if a currently acquired measurement value (MOP, MT, MCO) of the at least one fire characteristic variable (OPT, TEMP, CO) exceeds a respective predefined first threshold value (OG, TG, COG), to acquire the measurement values (MOP, MT, MCO) of the at least one fire characteristic variable (OPT, TEMP, CO) further continuously, in particular seamlessly, and to store them in the ring buffer (RING), and to form the incident data record (REC) from the saved historical measurement values (HIST) and from the further continuously acquired and stored measurement values (MOP, MT, MCO) together with the header data (HEADER).

In some embodiments, the control unit of the fire alarm device (2) is configured to reduce the stored measurement values (MOP, MT, MCO) of the at least one fire characteristic variable (OPT, TEMP, CO) in their data volume by means of a computer program executed on the control unit in order to perform a lossless or a minimally lossy data reduction method.

As another example, some embodiments include a central fire alarm system for operation on a common detector line (ML) with a plurality of fire alarm devices (2) as claimed in one of the preceding claims 13 to 21 as well as, where appropriate, with further fire detectors, alarm devices and/or manual call points (3), wherein the central fire alarm system (1) comprises a control unit which is configured to receive an incident data record (REC) via the detector line (ML) from the respective fire alarm devices (2) in multiple temporally distributed data transmission blocks (DAT), and to assemble the respective incident data record (REC) by evaluating its header data (HEADER), in particular by evaluating its file organization data (FILE), piece by piece to form the respective incident data record (REC) and store it in a database (DB).

In some embodiments, the control unit of the central fire alarm system (1) is configured to extend a respective assembled incident data record (REC), in particular its header data (HEADER), by at least one piece of supplementary information (ZI; ZTIME, ZAL, MCP, Y/N) acquired on the central system side by the central fire alarm system (1) and temporally assignable to the respective incident data record (REC) and to store it as an extended incident data record (REC+) in the database (DB), wherein supplementary information (ZI) on the central system side comprises a system time (ZTIME) of the central fire alarm system (1) and/or a fire alarm (AL) detected on the central system side and/or an alarm level detected on the central system side and/or a manual call point alarm (MCP) and/or a user-side input concerning the presence of an actual fire or a false alarm.

In some embodiments, the control unit of the central fire alarm system (1) is configured to store a respective incident data record (REC) or a respective extended incident data record (REC+) in a database (DB) of the central fire alarm system (1).

In some embodiments, the control unit of the central fire alarm system (1) is configured to store a respective incident data record (REC) or a respective extended incident data record (REC+) in a database (DB) of a cloud infrastructure (CLOUD) connected to the central fire alarm system (1) for data communication purposes.

In some embodiments, the fire alarm system comprising a central fire alarm system (1), and at least one detector line (ML) connected to the central fire alarm system (1) with in each case, connected thereto, a plurality of fire alarm devices (2) described herein as well as, where appropriate, with further fire detectors, alarm devices and/or manual call points (3) connected thereto.

### BRIEF DESCRIPTION OF THE DRAWINGS

The above-described characteristics, features and advantages of the teachings herein, as well as the manner in which these are achieved, will become clearer and more readily understandable in connection with the following description of the exemplary embodiments, which are explained in more detail in conjunction with the drawings. In these schematic views:

FIGS. 1-3 show exemplary characteristic curves of different fire characteristic variables during an occurring fire incident;

FIG. 4 shows an example of incident data records from fire alarm devices transmitted in a distributed manner to a higher-ranking central fire alarm system incorporating teachings of the present disclosure;

FIG. 5 shows an exemplary data structure of an incident data record incorporating teachings of the present disclosure;

FIG. 6 shows an exemplary data structure of an extended incident data record incorporating teachings of the present disclosure; and

FIG. 7 shows an example of a cloud infrastructure in each case with a connection for data communication purposes to a central fire alarm system and to a computer (tablet) for subsequent user-side assessment of incident data records.

### DETAILED DESCRIPTION

Some examples of the teachings herein include a fire alarm device with at least one fire sensor for acquiring a respective fire characteristic variable, a data memory and a (first) control unit connected to said data memory. The control unit is configured to acquire measurement values of at least one respective fire characteristic variable and to output a fire alarm in the event of a fire being detected. The control unit is additionally configured to buffer continuously acquired measurement values of at least one respective fire characteristic variable in the data memory if at least one respective measurement value of the at least one fire characteristic variable exceeds a respective predefined first threshold value. The fire sensor can comprise an optical fire sensor, in particular an optical measurement chamber according to the scattered light principle. In some embodiments, the fire sensor can comprise a temperature sensor, in particular an NTC. In some embodiments, the fire sensor can comprise a CO and/or CO₂ gas sensor. Some embodiments include a suitable central fire alarm system and a suitable fire alarm system.

Methods and fire alarm devices of said type are known e.g. from US 2015/084765A1, from US 2015/097687 A1 or from US 2017/257826 A1. The known prior art fire alarm devices are interconnected in a wireless network. The fire alarm device disclosed in US 2015/084765A1 and connected to a higher-ranking Home Network Manager can in this case comprise an incident data recorder in the form of a fireproof flight data recorder. Such an incident data recorder is configured and/or constructed to withstand a fire. For example, the data stored in the incident data recorder and/or information from the incident data recorder can be restored even if the fire alarm device has been destroyed in some other way during the fire incident.

The fire alarm devices disclosed in US 2015/097687 A1 and US 2017/257826 A1 are connected to a central server or a cloud computing system or to a base unit. In this case the data transmission rate for transferring measurement values from a wireless fire alarm device to the server or cloud computing system generally poses no problem with regard to evaluating the acquired measurement values e.g. in the cloud.

The data transmission rate in safety-related wired fire alarm systems is severely constrained. This applies in particular to fire alarm systems that comprise a central fire alarm system having one or more detector lines connected thereto, in each case comprising a plurality of fire alarm devices, manual call points and optical and/or acoustic alarm devices. A further factor is that every subscriber connected to the detector line via the central fire alarm system must be supplied with electrical power.

For safety reasons, such a detector line is in most cases connected to a central fire alarm system in a ring configuration referred to as a detector loop comprising a series of intermediately connected isolators. The reason for the latter is in order in a fault situation, such as e.g. in the event of an open-circuit fault, short circuit or ground fault, to supply the subscribers with power “from the other side” and to reach them for data communication purposes. In order to enable e.g. 250 subscribers to be operated at low voltage “on a loop” having a length of 2500 m and at a line resistance of 75-180 ohms, one subscriber may only have a power consumption of <1 mA for providing the detector function and for communication.

In contrast thereto, DSL connections are pure point-to-point connections. For DSL or other broadband methods, the higher the frequency, all the more electrical driver power is required in order to modulate the transmission signals onto the DSL cable.

For energy and cost reasons, the data transmission in the case of such fire alarm systems is realized in a baseband. In this case the line attenuation acting like an RC low-pass filter at a maximum extension of the detector line up to 3300 meters as well as reflections occurring due to stub lines and further a required maintaining of functional integrity in the event of line faults on the detector line by means of isolators disadvantageously limit the possible data or symbol rate. The high number of subscribers on the detector line, which, due to the short-circuit limiting, often also loop isolating elements into the line, cause a large number of variations in impedance.

A cable having unknown electrical properties that is present already from a predecessor fire alarm system in the building is often required to be used as a detector line. The technical requirement therefore often dictates that the fire alarm system must make do with any detector line in accordance with the “runs on any wire” principle, i.e. with or without shielding as well as with or without transposition. Only the wire cross-sections of the individual conductors of the detector line must lie in a range between 0.25-1.5 mm².

There are in fact approaches for establishing a more homogeneous line impedance by means of adaptive terminating elements in each subscriber. However, if a line fault occurs, such as an open-circuit fault, a ground fault or a short-circuit, this leads to unpredictable changes in the topology of the detector line. In this situation, the adaption time required after such a fault is much too long before the detector line, and hence the fire alarm system, once again functions reliably and is ready for operation according to specifications.

In contrast thereto, in the case of a DSL connection, a longer “training phase” is required in order to trim or equalize the line section. For these reasons and due to the fact that approx. 75% of the available transmission time is required for supplying power to the connected subscribers, system limitations mean that only a data transmission rate of max. 1000 bps in total is available for both transmission directions.

Modern-day line-connected fire alarm devices make the overall decision “fire—no fire” on the basis of an algorithm that is implemented in the fire alarm device itself. In almost all fire alarm systems, only the value “fire—no fire” is transmitted to the central fire alarm system. In some cases—as with the FS20 fire detection system of the applicant-intermediate values in the form of danger levels (DL 0, DL 1, DL 2 and DL 3) are also transmitted.

The reason for this is the previously cited severely limited transmission bandwidth or low data transmission rate. A further reason is that due to the very low electrical power available for a fire alarm device there is insufficient “computing power” available to be able to perform further computationally intensive evaluations also within a required alarm time in addition to the comparatively power-intensive metrological fire detection.

Overall, therefore, no “online” data transmission of a plurality of fire alarm devices with the central fire alarm system is possible in order to transfer the respective measurement values originating from the fire alarm devices to the central fire alarm system, in particular over multiple channels.

Teachings of the present disclosure include methods for recording measurement values, in particular raw measurement values, and for performing the further processing thereof in a line-connected fire alarm system. Some embodiments include an improved fire alarm device of the type cited in the introduction for operation in a line-connected fire alarm system and/or a suitable central fire alarm system as well as a suitable fire alarm system.

Measurement values relating to at least one significant fire characteristic variable indicating a potential fire incident and detected by a fire alarm device are recorded. In this case a central fire alarm system together with a plurality of such fire alarm devices is connected to the fire alarm devices via a common detector line for supplying the fire alarm devices with electrical energy as well as for transmitting data. In other words, the central fire alarm system is not connected to the fire alarm devices by wireless means.

The plurality of subscribers operated on a common detector line, i.e. the fire alarm devices, of other alarm devices such as alarm strobe lights and I/O units, manual call points and isolators, amounts to at least 10, in particular at least 25 and preferably at least 50. Furthermore, if a current measurement value of the at least one fire characteristic variable exceeds a respective predefined first threshold value as an indicator of a potential fire incident, measurement values are temporarily stored as a recording in a data memory of the respective fire alarm device. On completion of the recording, an incident data record is formed from the respective measurement values together with header data.

Finally, an incident data record is distributed in time by the respective fire alarm device and transmitted by way of multiple data transmission blocks released by the central fire alarm system to the central fire alarm system, in particular at a lower priority.

A respective incident data record transferred to the central fire alarm system can subsequently be processed further in a computer system, such as e.g. based on a Linux, Windows or iOS operating system, for the purpose of data-oriented analysis. Such a file can bear e.g. the file extension .REC. The transferred incident data records can be stored e.g. in a data memory of the central fire alarm system, in particular in a database of the central fire alarm system, and then be read out via a connected computer system. In some embodiments, the incident data records transferred to the central fire alarm system can be transmitted via a data link, in particular via an internet connection, into the “cloud”. By “cloud” is meant that the incident data records can be transferred to a cloud infrastructure, in particular into a database of the cloud infrastructure. A user can then access this database by means of an internet-enabled computer system.

An incident data record forms in particular a container file which includes as a data structure multiple recordings of measurement values in the manner of a measurement value data stream. These enclosed recordings of measurement values may be limited to fixed formats. The multichannel recordings together produce a logical whole, consolidated in a “container”.

The memory for storing the measurement values in the fire alarm device may be an internal read-only memory, such as e.g. a FRAM, EEPROM or flash memory. For greater volumes of data, the memory may also be an SSD (SSD standing for solid state disk).

In some embodiments, an average data transmission rate between a fire alarm device and the central fire alarm system is in particular smaller by a multiple than an average storage data rate for storing an incident data record in the respective fire alarm device. By “multiple” is meant that the average data transmission rate between a fire alarm device and central fire alarm system is in the range of 2 to 100 times, in particular in the range of 5 to 25 times, less than the average storage data rate for storing an incident data record. In other words, the storage data rate required for storing the data contents of an incident data record is much too great for enabling a measurement value data stream accumulating in a fire alarm device to be transmitted in any way “online” to the central fire alarm system.

Thus, the measurement values for a smoke density that is to be detected typically have a bit width in the range of 10 bits to 16 bits. In the case of a 16-bit resolution, an acquired measurement value therefore comprises a value range of 2 to the power of 16=65536. A measurement value can therefore assume numeric values from 0 to 65535 “counts” as the output value of an A/D converter. The sampling rate for acquiring a measurement value from an optical scattered light signal originating from a photosensor preferably lies in the range of 1 Hz to 4 Hz.

The measurement values for a temperature that is to be measured in the vicinity of a fire alarm device typically have a bit width in the range of 8 bits to 14 bits. In the case of a 14-bit resolution, an acquired measurement value comprises a value range of 2 to the power 14=16384. A measurement value can therefore assume numeric values from 0 to 16383 counts. The sampling rate for acquiring a measurement value from an analog temperature signal originating from an NTC as temperature sensor preferably lies in the range of 0.1 Hz to 1 Hz.

The measurement values for a concentration of carbon monoxide (CO) that is to be detected typically has a bit width in the range of 8 bits to 10 bits. The sampling rate for acquiring a measurement value from a CO concentration originating from a CO gas sensor preferably lies in the range of 0.5 Hz to 2 Hz.

If, for example, two optical scattered light signals at 14-bit resolution, a temperature signal at 10-bit resolution and a CO measurement signal at 10-bit resolution are recorded at a sampling rate of 1 Hz in a fire alarm device, then the average data transmission rate for storing the corresponding digital measurement values amounts to=2×14 bits+10 bits+10 bits=48 bits per second=48 bps.

In some embodiments, the time period for a transmission frame amounts to 250 ms. If e.g. 200 fire alarm devices or other alarm devices are operated on a common detector line, then the duration of a circulation cycle amounts to 200×250 ms=50 seconds. Accordingly, a data transmission block allocated to a fire alarm device for the data transmission between the fire alarm device and the central fire alarm system is available only every 50 seconds, that is, provided such a data transmission block can be released at all by the central fire alarm system on account of otherwise possibly higher-priority data traffic. If such a data transmission block makes e.g. 32 bits available every 50 seconds, this is equivalent to an average data transmission rate of 32 bits: 50 seconds=0.64 bps. A transmission of the acquired measurement values, in this case, by way of example, via four channels, from a fire alarm device to the central fire alarm system is therefore in no way possible in real time. This does not apply above all when the number of subscribers operated on a common detector line, such as fire alarm devices, other alarm devices such as alarm strobe lights and I/O units, manual call points and isolators, amounts to at least 10, in particular at least 25 and preferably at least 50.

The teachings do not include improving the “fire—no fire” decision by transferring measurement values or raw data in real time into the cloud and evaluating these values automatically by means of a more sophisticated algorithm having higher computing resources in order, if necessary, to output a fire alarm. This is not possible due to the limited transmission width in a line-connected fire alarm system with the plurality of fire alarm devices connected thereto.

The incident data records acquired as a result of a fire characteristic variable threshold value being exceeded as an indicator of a potential fire incident in the fire alarm devices are transmitted in the background, i.e. at a lower priority and a portion at a time, to the central fire alarm system and collected there in a database. If the database is stored e.g. in a network known as a “cloud”, then it is possible, with the computing power available there and with the sophisticated analytical tools based on artificial intelligence and deep learning available there, to attain detailed findings concerning the origin and development of a fire as well as for differentiating interference variables such as dust and water vapor. These findings can advantageously be used in turn for improving the fire detection algorithms in the fire alarm devices at the site.

In some embodiments, the header data comprises, as data fields, file organization data and/or a detector ID and/or a recording time. In some embodiments, the header data may comprise a recording format or a detector type as data fields. In some embodiments, the header data may further comprise detector-side supplementary information relating to a detector event as a data field. A detector event may be an alarm level generated independently by the respective fire alarm device, a fire alarm or a pre-alert.

The header data may also be referred to as a “header” which structures the data logged in a respective incident data record and to be transmitted. At the same time the file organization data may comprise the storage volume or file size of an incident data record. The file organization data may additionally comprise a table in the form of a “FAT” (FAT standing for File Allocation Table) which references sequential data blocks of an incident data record that are to be transmitted distributed in time.

The header data may also include a detector identifier, such as e.g. a detector ID, a current bus address or a serial number of the fire alarm device. This enables a logged incident data record to be uniquely assigned to a fire alarm device on the detector line.

The recording time may comprise e.g. the start time in the form of a timestamp, the end time and/or the time period of an incident data record. The start time may come e.g. from a real-time clock integrated in the fire alarm device and comprises in particular the date as well as the current time of day of a logged incident data record. In some embodiments, the start time may be determined from a real time preferably transmitted via the detector line at regular intervals by the central fire alarm system, which real time synchronizes a detector-internal clock e.g. in the form of a counter. In some embodiments, the start time may also be a relative time with respect to a reference time. The reference time may be based e.g. on a predefined date and on a predefined time of day, such as e.g. on Jan. 1, 2020/00:00 hours or on the date and on the time of day of the commissioning of a fire alarm device.

The recording format may comprise e.g. a number of logged measurement value data streams, such as e.g. the number 3 in the case of a recorded smoke density, temperature and CO concentration. The recording format may further include the sampling rate and/or the measurement value range of the respective logged measurement value data streams. In some embodiments, the recording format with the respective recording parameters, such as e.g. number of measurement value data streams, sampling rate, etc., may already be assigned to a detector type, on the basis of which the central fire alarm system receiving a respective incident data record can then perform the evaluation.

In some embodiments, the header data of an incident data record may also include detector-side supplementary information relating to a detector event. Such a detector event may be e.g. an alarm level generated independently by the fire alarm device, such as e.g. a fire alarm or a so-called pre-alert.

By supplementing a logged incident data record with its recording time (date and time of day), with the detector ID or bus address of the fire alarm device, as well as with the presence of a fire alarm or pre-alert detected by the fire alarm device, it is subsequently advantageously possible to conduct a more precise analysis to determine whether the incident concerned an actual fire or fire alarm or a false alarm, this being coincidental in time with, where applicable, further incident data records received from other fire alarm devices.

By “coincidental in time” is meant that the fire alarms output in relation to a fire incident by a fire alarm device as well as by further fire alarm devices and manually triggered manual call points in the neighborhood of the triggering seat of the fire took place within a time period of 10 minutes, in particular of 5 minutes.

In some embodiments, the data transmission between a fire alarm device and the central fire alarm system is performed in circulation cycles with sequentially succeeding transmission frames for each fire alarm device. In a transmission frame there is provided in each case a data transmission block releasable by the central fire alarm system for the data transmission from the respective fire alarm device to the central fire alarm system. A data transmission block in this case comprises in particular a volume of data in a range of just 8 bits up to 96 bits.

The duration of a circulation cycle is substantially dependent on the number of fire alarm devices operated on a detector line as well as, where applicable, further manual call points and optical and acoustic alarm devices. In the fire alarm system deployed by the applicant, the time taken for a transmission frame amounts to 250 ms. If e.g. 200 of the previously cited detectors and alarm devices are operated on a common detector line, the duration of a circulation cycle amounts to 200×250 ms=50 seconds.

By “the data transmission block releasable in a transmission frame by the central fire alarm system” is meant that a connected central fire alarm system, in response to a targeted request from a respective fire alarm device, is prompted to make transmission time available—if possible—for a data transmission block in this transmission frame or starting from one of the following transmission frames, i.e. provided the requested transmission time is not required by other currently more important transmission services in the fire alarm system. A targeted request by a fire alarm device to the central fire alarm system can be made e.g. following termination of a complete logging of an incident data record by a respective fire alarm device.

To expedite the transmission of a terminated complete incident data record, the targeted request to provide a data transmission block within the transmission frame allocated to the respective fire alarm device per circulation cycle may include the request to provide further data transmission blocks in other transmission frames per circulation cycle, such as e.g. the request to provide two to ten data transmission blocks per circulation cycle.

In some embodiments, the maximum data transmission rate amounts to 10 kbps, in particular 2 kbps, e.g. 1 kbps. As described in the introduction, this comparatively low data transmission rate is due to the indeterminate state of the installed electrical detector line with the plurality of detectors and alarm devices connectable thereto with at the same time the least possible electrical supply power. The cited data transmission rate is in particular a net data transmission rate. Often, up to 75% of the available transmission time is used (exclusively) for transferring energy for the electrical supply to the connected fire alarm device and other alarm devices.

In some embodiments, the measurement values of the at least one fire characteristic variable are acquired at a higher sampling rate and are stored in the data memory of the respective fire alarm device if one of the respective predefined first threshold values has been exceeded. This may enable a potentially impending fire incident to be detected at a temporally higher resolution and to be analyzed subsequently in greater detail. The measurement values can be acquired e.g. at twice or four times the temporal resolution, such as e.g. at a sampling frequency of 1 Hz or 2 Hz for the case whereby, during normal operation of a fire alarm device, a measurement value is sampled at a sampling frequency of 0.5 Hz.

In some embodiments, a respective incident data record received by the central fire alarm system, in particular its header data, is extended by at least one piece of supplementary information acquired on the central system side by the central fire alarm system and temporally assignable to the respective incident data record. Supplementary information on the central system side in this case comprises a system time of the central fire alarm system and/or a fire alarm detected on the central system side and/or an alarm level detected on the central system side and/or a manual call point alarm and/or a user-side input concerning the presence of an actual fire or of a false alarm. The incident data record extended in said manner is stored in a database of the central fire alarm system or in a database of a cloud infrastructure connected for data communication purposes to the central fire alarm system to allow the further possible, where appropriate partly automated, assessment of the extended incident data records by a user for the presence of an actual fire.

The system time can be taken from a real-time clock of the central fire alarm system. In some embodiments, it can come from a real-time clock reachable by data communication means. The latter clock can be synchronized with an atomic clock e.g. via an active internet connection.

It is of particular interest in this case if the central fire alarm system, coincidentally in time with a received incident data record from a fire alarm device, in particular by evaluation of its recording time (start time), receives further fire alarms via the detector line at more or less the same time from fire alarm devices or manual call points in spatial proximity to one another. It can then be assumed here with higher probability that an actual fire alarm is concerned, and not a false alarm. If a central fire alarm system receives an incident data record in each case from neighboring fire alarm devices, in particular of one detector line, having approximately the same recording time, then it can be assumed that it is a matter of an actual fire incident. By “coincidentally in time” in this instance is meant that the recording times of the individual incident data records lie within a time window of 10 minutes, in particular of 5 minutes and preferably within 3 minutes.

If the presence of an actual fire or of a false alarm has been acknowledged manually at the central fire alarm system, this user-side input is particularly significant and valuable as central-system-side supplementary information during a subsequent analysis of an incident data record.

In some embodiments, the continuous acquisition of the measurement values of the at least one fire characteristic variable in the respective fire alarm device is terminated
if a predefined acquisition time period, such as e.g. in a range of 30 seconds to 15 minutes, is reached for a respective incident data record, or
if the free storage capacity of the data memory has been exhausted, or
a fire alarm or an alarm level is generated by the respective fire alarm device, or
if a respective predefined second threshold value is exceeded which is greater than the associated respective first threshold value, or
if the respective predefined first threshold value is undershot once more, or
if a STOP command is received by the respective fire alarm device from the common detector line in order to terminate the continuous acquisition.

If a second predefined threshold value is exceeded, it can be assumed that an actual fire incident is concerned. Acquired fire characteristic variables having such high measurement values then comprise no further significant supplementary information for the subsequent analysis.

In some embodiments, a respective formed incident data record for buffering is initially stored sequentially in a buffer organized in the data memory of the respective fire alarm device. The incident data records stored in the buffer of the respective fire alarm device are then transferred sequentially in the released transmission time blocks from the respective fire alarm device to the central fire alarm system. This enables potential fire incidents closely succeeding one another in time or further fire developments, such as e.g. a renewed flare-up following a supposed extinguishing of a fire, to be stored even if a previously logged incident data record could not yet be transmitted in full to the central fire alarm system.

In some embodiments, after an incident data record has been stored in the buffer of a respective fire alarm device, measurement values are once again continuously acquired and stored if at least one respective measurement value again exceeds the respective predefined first threshold value as an indicator of a potential fire incident.

In some embodiments, the measurement values of the at least one fire characteristic variable are acquired continuously by the respective fire alarm device and stored in a ring buffer organized in the data memory of the respective fire alarm device having a predefinable circulation time. The measurement values stored in the ring buffer are then saved as historical measurement values, i.e. as measurement values preceding in time, in the data memory of the respective fire alarm device if at least one respective measurement value of the at least one fire characteristic variable exceeds a respective predefined first threshold value as an indicator of a potential fire incident. In addition, the measurement values of the at least one fire characteristic variable are acquired and stored further continuously by the respective fire alarm device, in particular further continuously in a seamless manner. Finally, the respective incident data record is then formed from the saved historical measurement values, from the further continuously acquired measurement values stored in the ring buffer and from the header data.

The time period prior to the triggering fire incident or false alarm is also available for a subsequent metrological analysis as history, as it were. In this case the ring buffer can be embodied such that the acquired measurement values for a previous time period in the range of 30 seconds to 15 minutes can be stored there. In the process, the oldest measurement values are once again overwritten by currently acquired measurement values.

In some embodiments, the measurement values of the at least one fire characteristic variable are advantageously reduced in their data volume by means of a lossless or by means of a minimally lossy data reduction method. By “minimally” is meant that a data-reduced measurement value differs in its amount by a maximum of 5 percent, in particular by a maximum of 3 percent, from the amount of an actual measurement value.

In the case of lossless data reduction methods, e.g. an entropy coding, such as e.g. an entropy coding by means of a Huffman code or an arithmetic coding, may be considered suitable. In the case of lossy data reduction methods, e.g. a reduction in resolution during the acquisition of one of the fire characteristic variables is possible. In this case the number of bits for representing a measurement value is reduced, such as e.g. from 12 bits to 10 bits or from 10 bits to 8 bits. In some embodiments, the sampling rate during the acquisition of one of the fire characteristic variables can be reduced, such as e.g. from 2 Hz to 1 Hz, from 1 Hz to 0.5 Hz or from 1 Hz to 0.1 Hz.

To avoid repetitions, with regard to the fire alarm device described below as well as to the respective following variants of the fire alarm device, reference is made to the explanations and supplementary statements in the respective previous corresponding method variants. In terms of their disclosure content, these apply herewith also to the disclosure content of the following fire alarm device and its variants.

In some embodiments, the fire alarm device is configured for operation on a common detector line with a central fire alarm system for supplying electrical energy to the fire alarm device, for outputting a fire alarm if a fire is detected and for data communication with the central fire alarm system. The control unit is configured to form an incident data record from the measurement values logged in the data memory of the fire alarm device together with header data. The control unit is further configured to transmit the incident data record in a temporally distributed manner via data transmission blocks released by the central fire alarm system to the central fire alarm system, in particular at a lower priority.

The control unit of the fire alarm device is configured in particular, following completion of an incident data record in the data memory of the fire alarm device, to output a request for a data transmission block to be provided within the transmission frame allocated to the respective fire alarm device per circulation cycle onto the connected detector line, i.e. to the central fire alarm system. The control unit may be further configured to output, together with the first request, a further request for further data transmission blocks to be provided in other remaining transmission frames per circulation cycle onto the connected detector line, i.e. to the central fire alarm system, such as e.g. the request for two to ten data transmission blocks to be provided per circulation cycle.

The (electronic) control unit may be a microcontroller which is usually present or necessary “anyway” for the overall control of a fire alarm device. Furthermore, the microcontroller may comprise one or more integrated A/D converters for metrologically acquiring the previously described fire characteristic variables, such as smoke density, temperature or CO or CO₂ concentration. It may additionally comprise analog and/or digital input and output units (I/O) as well as communication interfaces for outputting a fire alarm. The first and second threshold value for the respective fire characteristic variable may be stored in the microcontroller in a nonvolatile memory (EPROM) of the microcontroller or in a data memory of the detector. In addition, drive units, such as e.g. for the light emitters (LEDs) and/or electronic components for the signal conditioning or signal processing of the previously cited fire characteristic variables, may already be integrated in the microcontroller.

In some embodiments, the fire alarm device is configured to store a respective incident data record at an average storage data rate DRM in the data memory of the fire alarm device, the average data transmission rate DRZ between the fire alarm device and the central fire alarm system being in particular less by a multiple than the average storage data rate DRM. In other words, the storage data rate required for storing an incident data record is much too great to enable the measurement value data stream accruing in a fire alarm device to be transferred in any way “online” to the central fire alarm system.

In some embodiments, the header data comprises file organization data and/or a detector ID and/or a recording time. In some embodiments, the header data may include a recording format or a recording type. If necessary, the header data may comprise detector-side supplementary information relating to a detector event, a detector event being an alarm level generated independently by the respective fire alarm device, a fire alarm or a pre-alert.

In some embodiments, the control unit is configured to transmit the incident data record by way of multiple temporally distributed data transmission blocks temporally allocated to the fire alarm device and released by the central fire alarm system to the central fire alarm system. A data transmission block in this case comprises in particular a volume of data in a range of 8 bits to 96 bits.

In some embodiments, the control unit is configured to acquire the measurement values of the at least one fire characteristic variable at a higher sampling rate, in particular at twice or four times the sampling rate, after one of the respective predefined first threshold values has been exceeded.

In some embodiments, the control unit is configured to terminate the continuous acquisition of the measurement values of the at least one fire characteristic variable in the fire alarm device
if a predefined acquisition time for logging the incident data record is reached, or
if the free storage volume of the data memory has been exhausted, or
if a fire alarm or an alarm level is generated by the control unit, or
if the respective predefined second threshold value, which is greater than the associated respective first threshold value, is exceeded, or
if the respective predefined first threshold value is undershot once more, or
if a STOP command from the common detector line in order to terminate the continuous acquisition is received by the control unit.

In some embodiments, the fire alarm device has a buffer organized in the data memory of the fire alarm device. The control unit is configured to temporarily store a respectively formed incident data record initially sequentially for buffering in the buffer. The control unit is further configured to then transmit the buffered incident data records once again sequentially in the released data transmission blocks to the central fire alarm system.

In some embodiments, the fire alarm device comprises a ring buffer organized in the data memory of the fire alarm device and having a predefinable circulation time. The control unit is configured to acquire the measurement values of the at least one fire characteristic variable continuously and to store them in the ring buffer and to save the measurement values stored in the ring buffer as historical measurement values, i.e. as measurement values preceding in time, if a currently acquired measurement value of the at least one fire characteristic variable exceeds a respective predefined first threshold value. The control unit is further configured to acquire the measurement values of the at least one fire characteristic variable further continuously, in particular seamlessly, and then to store them. Finally, the control unit is configured to form the incident data record from the saved historical measurement values and from the further continuously acquired and stored measurement values together with the header data.

In some embodiments, the control unit of the fire alarm device is configured to reduce the stored measurement values of the at least one fire characteristic variable in their data volume by means of a computer program executed on the control unit in order to perform a lossless or a minimally lossy data reduction method.

In some embodiments, the central fire alarm system is configured for operation on a common detector line with a plurality of fire alarm devices as well as where appropriate with further fire alarm devices, other alarm devices and/or manual call points. The central fire alarm system comprises a (second) control unit which is configured or programmed to receive an incident data record via the detector line from the respective fire alarm devices in multiple temporally distributed data transmission blocks and to assemble the respective incident data record by evaluating its header data, in particular by evaluating its file organization data, piece by piece or step by step to form the respective incident data record and store it in a database. A central fire alarm system of this type may also be referred to as a control center or as a control panel. The control unit of the central fire alarm system is preferably an electronic processor-based control unit on which a suitable software program is executed.

By “the data transmission block releasable in a transmission frame by the central fire alarm system” is meant that a connected central fire alarm system, in response to a targeted request from a respective fire alarm device, is prompted to make transmission time available—if possible—for a data transmission block in this transmission frame or starting from one of the following transmission frames, i.e. provided the requested transmission time is not required by other currently more important transmission services in the fire alarm system.

In particular, following reception of a request to provide a data transmission block within the transmission frame allocated to the respective fire alarm device per circulation cycle, the control unit of the central fire alarm system is configured to release transmission time—if possible—for a data transmission block in this transmission frame or starting from one of the following transmission frames.

The control unit of the central fire alarm system may be further configured, following reception of the request together with a prompt to provide further data transmission blocks in other remaining transmission frames per circulation cycle, to release further transmission time—if possible—in data transmission blocks in other remaining transmission frames.

In some embodiments, the control unit of the central fire alarm system is configured or programmed to extend a respective assembled incident data record, in particular its header data, by at least one piece of supplementary information acquired by the central fire alarm system and temporally assignable to the respective incident data record on the central system side and to store it in the database as an extended incident data record. In this case supplementary information on the central system side comprises a system time of the central fire alarm system and/or a fire alarm detected on the central system side and/or an alarm level detected on the central system side and/or a manual call point alarm and/or a user-side input concerning the presence of an actual fire or of a false alarm.

To avoid repetitions, with regard to the central fire alarm system according to the invention as well as to its variants, reference is made to the explanations and supplementary statements in the respective previous corresponding method variants as well as in the device claims directed to a fire alarm device, to which the considered central fire alarm system makes reference. In terms of their disclosure content, these apply herewith also to the disclosure content of the preceding variants.

In some embodiments, the control unit of the central fire alarm system is configured or programmed to store a respective incident data record or a respective extended incident data record in a database of the central fire alarm system.

In some embodiments, the control unit of the central fire alarm system is configured to store a respective incident data record or a respective extended incident data record in a database of a cloud infrastructure connected for data communication purposes to the central fire alarm system. This enables the incident data records stored there to be processed further by means of cloud-based, complex and compute-intensive analytical tools, detached from the actual monitoring function of the central fire alarm system. For this purpose, the central fire alarm system can be connected for data communication purposes to the cloud infrastructure via a wired (e.g. LAN) or via a wireless internet interface (e.g. 3G, 4G, 5G, WLAN).

Some embodiments include a fire alarm system which comprises a central fire alarm system as described herein, at least one detector line connected to the central fire alarm system with a plurality of fire alarm devices incorporating teachings of the present disclosure connected thereto in each case and, where appropriate, with further fire alarm devices, other alarm devices and/or manual call points connected thereto. The fire alarm system may comprise a detector line, typically embodied as a two-wire cable. A detector line of said type can be several hundred meters to a few kilometers in length, such as e.g. in a range of 100 m to 3300 m. In addition, a detector line of said type can comprise a plurality of stub lines. In this case up to 250 fire alarm devices as well as optical and acoustic alarm devices and manual call points in total can be connected along such a detector line.

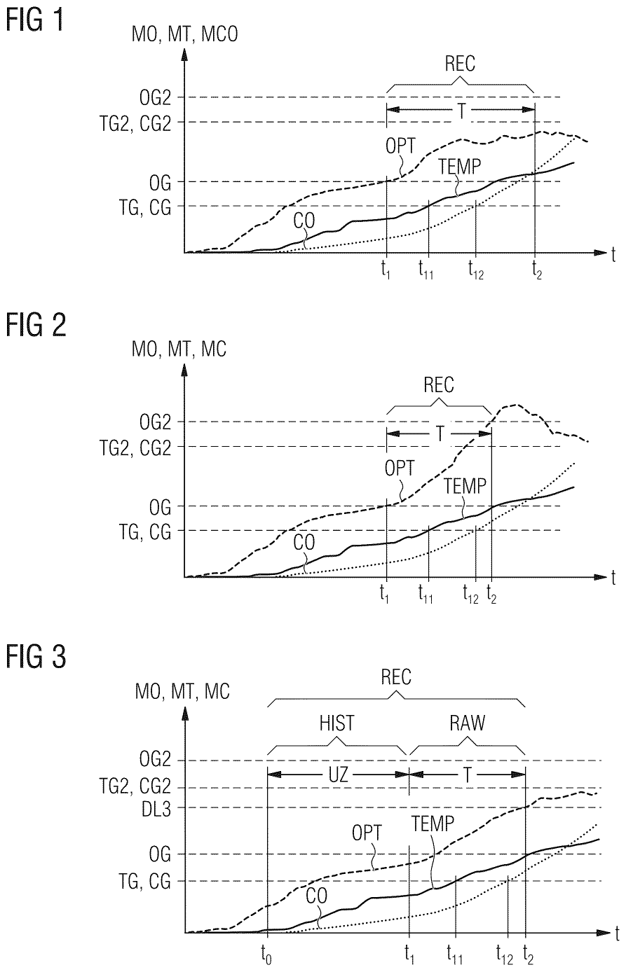

FIG. 1 shows an exemplary characteristic curve of different fire characteristic variables OPT, TEMP, CO, i.e. of a smoke density OPT, a temperature TEMP and a CO concentration, during an occurring fire incident. The associated measurement values MO, MT, MCO are plotted over time t in the form of “counts”. First threshold values of the measurement values MO, MT, MCO are designated by OG, TG, CG, and second threshold values by OG2, TG2 and CG2. It can be seen how the smoke density OPT, the temperature TEMP and the CO concentration CO increase in respect of the variation with time. At time point t₁, one of the fire characteristic variables, in this case the smoke density OPT, is first to exceed its respective first threshold value OG. Starting from said time point t₁, according to the invention, the logging of the associated measurement values MO, MT, MCO commences, in this case, by way of example, for all three “measurement channels” shown. At time points t₁₁ and t₁₂, the temperature TEMP and the CO concentration CO exceed their respective first threshold value TG, CG at the same count value by way of example. At time point t₂, further according to the invention, the logging of measurement values MO, MT, MCO is terminated after a predefined time period T has expired.

FIG. 2 shows a further exemplary characteristic curve of a smoke density OPT, a temperature TEMP and a CO concentration CO during an occurring fire incident. In this case, the logging of measurement values MO, MT, MCO is terminated at time point t₂ after a second threshold value OG2 is exceeded by a measurement value MO.

FIG. 3 shows a further exemplary characteristic curve of a smoke density OPT, a temperature TEMP and a CO concentration CO during an occurring fire incident. In this case associated measurement values MO, MT, MCO are acquired in a ring buffer with a circulation time UZ. At time point t₁, one of the fire characteristic variables, in this case once again the smoke density OPT, is first to exceed its respective first threshold value OG. The already acquired measurement values MO, MT, MCO in the ring buffer are temporarily stored as historical measurement values HIST and thus saved, and associated measurement values MO, MT, MCO are further continuously acquired seamlessly, i.e. without interruption. The logging of the measurement values MOP, MT, MCO following reception of a fire alarm DL3 detected by the fire alarm device is terminated at time point t₂ after a time period T. The previously saved historical measurement values HIST from the ring buffer and the measurement values RAW; MOP, MT, MCO further acquired thereafter in the time period T, together with the preceding header data, now form an incident data record.

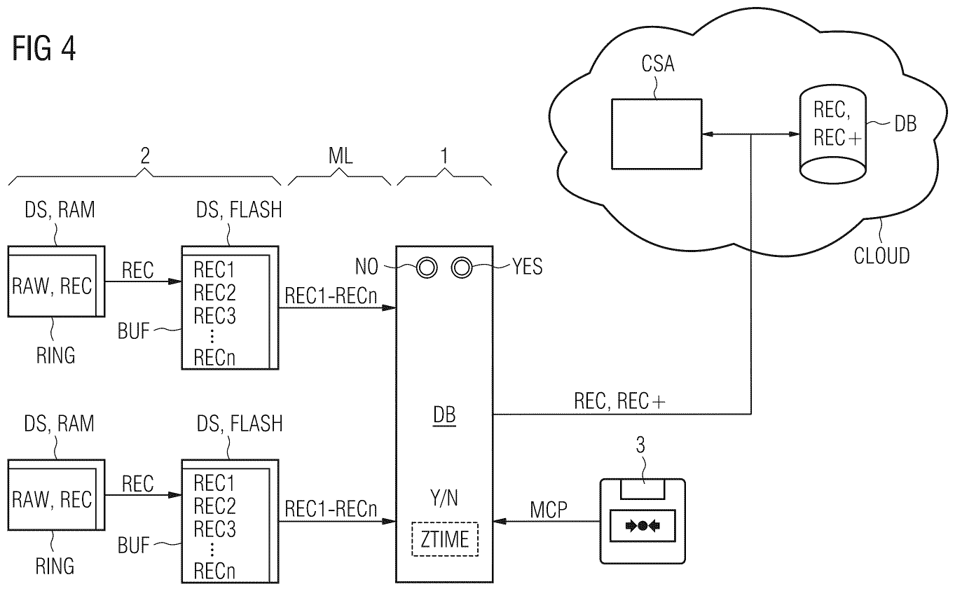

FIG. 4 shows an example of incident data records REC1-RECn transmitted in a distributed manner from fire alarm devices 2 to a higher-ranking central fire alarm system 1 incorporating teachings of the present disclosure. The fire alarm devices 2 shown in the left part of FIG. 4 each have an electronic data memory DS. A first part of the data memory DS is a RAM memory RAM organized as a ring buffer RING. This serves for saving measurement values MO, MT, MCO of a possible subsequent incident data record REC using data processing technology.

Shown alongside in each case is a second part of the data memory DS in the form of a nonvolatile flash memory FLASH. This serves as a buffer BUF, in particular as a FIFO buffer (“FIFO” standing for First In-First Out). In this case the incident data records REC completed in the first data memory RAM from the measurement values MO, MT, MCO are subsequently transferred to the buffer BUF and temporarily stored there. The incident data records REC1-RECn in the buffer BUF are then transferred by means of a control unit (not shown further) of the fire alarm device 2 in a temporally distributed manner, in particular at a lower priority, over a common detector line ML to the central fire alarm system 1 shown in the middle part of FIG. 4. In the process, an average data transmission rate between the fire alarm devices 2 and the central fire alarm system 1 is in each case in particular less by a multiple than an average storage data rate for storing the incident data record REC in the data memory DS, RAM.

The central fire alarm system 1 shown in the middle part of FIG. 4 comprises a control unit (not shown further) which is configured or programmed to receive an incident data record REC1-RECn from the respective fire alarm devices 2 in multiple temporally distributed data transmission blocks. The control unit is furthermore configured or programmed to then assemble the respective incident data record REC1-RECn by evaluating its header data, in particular by evaluating its file organization data, piece by piece to form the respective incident data record REC1-RECn and store it in a database DB. In some embodiments, the database DB can either be stored in the central fire alarm system 1 itself or it can be stored in a cloud infrastructure CLOUD connected for data communication purposes to the central fire alarm system 1. Further, the central fire alarm system 1 may already be configured to extend the incident data records REC1-RECn received in each case by information on the central system side, such as e.g. by a system time ZTIME of the central fire alarm system 1, by a user-side input Y/N via, by way of example, two acknowledgment pushbuttons NO, YES on the central fire alarm system 1 or by a manual call point alarm MCP received coincidentally in time from a manual call point 3.

Depicted in the right-hand part of FIG. 4 is a cloud infrastructure CLOUD, symbolized by a cloud. In addition to the already described database DB containing the received incident data records REC or extended incident data records REC+, this comprises a cloud application CSA executed in the “cloud” CLOUD. Said cloud application CSA is provided for conducting more detailed analyses of the received incident data records REC, REC+ in an at least partly automated manner e.g. based on deep-learning methods or artificial intelligence in order to obtain improved results concerning the origins of an actual fire or of a false alarm.

FIG. 5 shows an exemplary data structure of an incident data record REC incorporating teachings of the present disclosure. The incident data record REC shown is composed of a header data part HEADER, referred to in technical language as a “header”, and of a measurement values part MO, MT, MCO. The header data HEADER serves for structuring the incident data record REC shown. In particular, the file organization data FILE structures the respective start of the sequential blocks recorded by way of example in the measurement values part MO, MT, MCO and containing individual measurement values MOP₁, MOP₂, . . . , MOP_{X} for the smoke density OPT, individual measurement values MT₁, MT₂, . . . , MT_{X} for the temperature TEMP and individual measurement values MCO₁, MCO₂, . . . , MCO_{X} for the CO concentration. The following detector ID serves to provide a unique assignment of the recorded incident data record REC to a fire alarm device on the detector line ML. This is followed by a recording time TIME of the incident data record REC with date and start time in the manner of a timestamp and by the end time of the recording. Further data follows relating to the recording format AF or the detector type. The recording format AF comprises e.g. the number of measurement channels or measurement value data streams containing recorded measurement values, their type (scattered light signal, temperature signal, CO concentration signal) as well as the respective sampling rate and/or measurement value range of the recorded measurement channels or measurement value data streams. Finally, there follows, as detector-side supplementary information, an alarm level DL generated independently by the fire alarm device, i.e. whether a fire alarm has been detected by the fire alarm device in question or not. In the simplest case this is a bit in the header data HEADER.

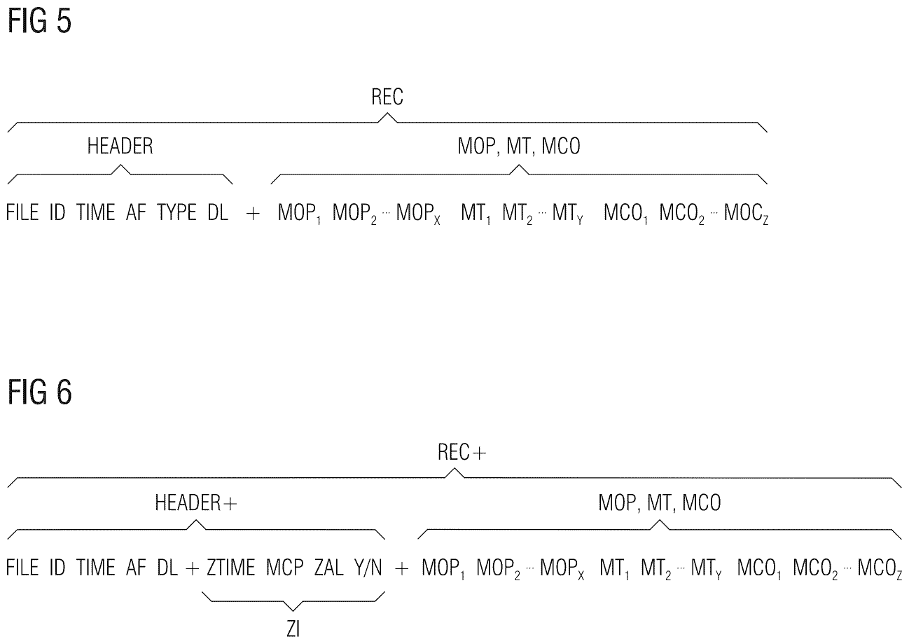

FIG. 6 shows an exemplary data structure of an extended incident data record REC+ incorporating teachings of the present disclosure. Compared to the previous FIG. 5, the original header data HEADER is extended in an incident data record REC transferred from the fire alarm device to the central fire alarm system by supplementary information ZI on the central system side. Following reception of the incident data record REC, this supplementary information ZI is extended or augmented by the central fire alarm system itself. The supplementary information ZI comprises e.g. a current system time ZTIME of the central fire alarm system, information about whether and which manual call point on the common detector line has triggered a fire alarm MCP coincidentally in time with the received incident data record REC. The supplementary information ZI further comprises a fire alarm ZAL detected on the central system side from further (automatic) fire alarm devices on the common detector line likewise coincidentally in time with the received incident data record REC. Finally, the supplementary information ZI comprises an input Y/N made on the user side by pressing of an acknowledgment pushbutton on the central fire alarm system itself to indicate whether the alarm was an actual fire alarm or a false alarm.

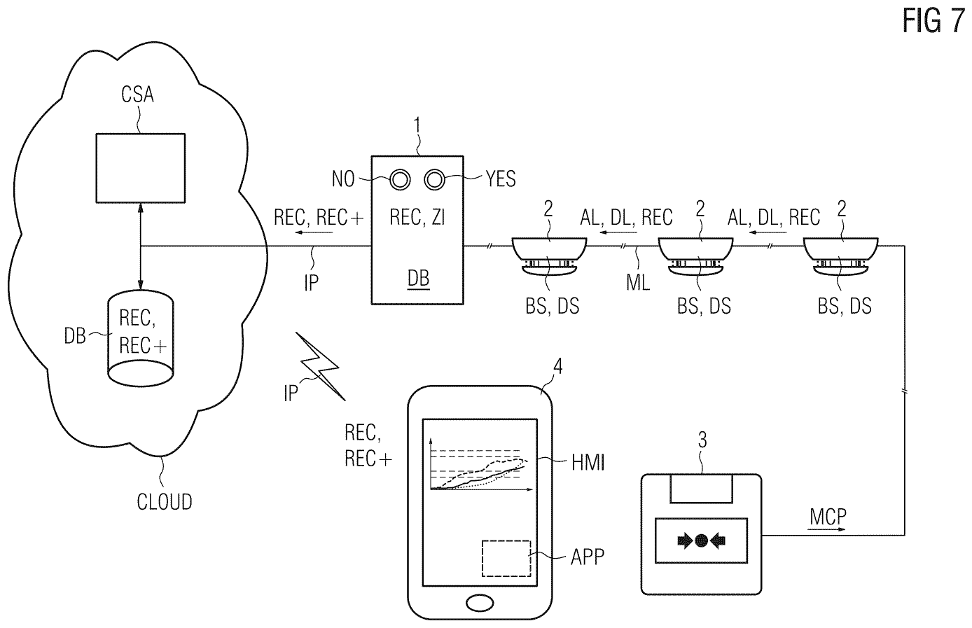

Finally, FIG. 7 shows an example of a cloud infrastructure CLOUD connected in each case for data communication purposes to a central fire alarm system 1 and to a computer 3 (tablet) to allow a subsequent user-side assessment of incident data records REC, REC+. A plurality of fire alarm devices 2 and a manual call point 3 are connected on a common detector line ML to a central fire alarm system 1. Each of the fire alarm devices 2 shown comprises a fire sensor BS having e.g. an optical measurement chamber, a temperature sensor or a CO sensor. The measurement values recorded according to the invention can be stored in a respective data memory DS of a fire alarm device 2. In this case the central fire alarm system 1 is configured to receive preferably addressed fire alarms AL, pre-alerts DL or manual call point alarms MCP arriving from the detector line ML. In addition, the central fire alarm system 1 is configured to receive incident data records REC transmitted in portions by the fire alarm devices 2 and to store these following termination of the transfer in a database DB in the central fire alarm system 1 and/or preferably to store these via an internet connection IP in a database DB of a cloud infrastructure CLOUD connected for data communication purposes to the central fire alarm system 1. The incident data records REC stored in the respective database DB may also have been extended already by the central fire alarm system 1 with supplementary information ZI added on the central system side to form extended incident data records REC+.

In the lower part of FIG. 7, a computer-based device 4, such as e.g. a tablet as shown, is connected via a further internet connection IP to the cloud infrastructure CLOUD, in particular controlled via a correspondingly programmed cloud application CSA of the cloud infrastructure CLOUD. The cloud application CSA is equipped with data communication means allowing write/read access to the incident data records REC or extended incident data records REC+ stored in the database DB in the cloud infrastructure CLOUD. An application APP is executed on the computer-based device 4 shown, allowing a user to load selected incident data records REC or extended incident data records REC+ and display them on a display HMI of the computer-based device 4. In the simplest case, an experienced user can conduct their own assessment in relation to the presented incident data records REC, REC+. A user can e.g. make entries in a reserved further field in the header data HEADER indicating whether the alarm was an actual fire alarm or not. In addition, further assessments or notes can be entered e.g. in a reserved comments field in the header data HEADER. The amended incident data records REC or extended incident data records REC+ can then be updated in the database DB following termination of the assessment.

Some embodiments include a method for logging measurement values MO, MT, MCO relating to significant fire characteristic variables OPT, TEMP, CO detected by a fire alarm device 2, wherein, if a measurement value exceeds a threshold value OG, TG, COG as an indicator of a fire incident, measurement values are temporarily stored as a log recorded in a data memory DS of the fire alarm device, wherein, on completion of the recording, a data structure in the form of an incident data record REC is formed therefrom together with header data HEADER, and wherein an incident data record is transferred at a lower priority by the fire alarm device in a temporally distributed manner and by way of multiple data transmission blocks released by a central fire alarm system 1 to the central fire alarm system. The invention further relates to a fire alarm device, a central fire alarm system and a fire alarm system.

### LIST OF REFERENCE SIGNS

1 Central fire alarm system, panel, BMZ
2 Fire alarm device, smoke detector
3 Manual call point, MCP
4 Computer, PC, mobile communication device, smartphone, tablet
AF Recording format
AL Fire alarm, master alarm
APP Application
BS Fire sensor, optical fire sensor, smoke gas sensor
BUF Buffer
CLOUD Cloud infrastructure
CO CO concentration, fire characteristic variable
CSA Cloud service application
DB Database
DL Alarm level, danger level
DL3 Fire alarm, fire alarm level
DS Data memory, RAM, flash memory
FILE File organization data
FLASH Flash memory
HEADER Header data, header
HEADER+ Extended header data, extended header
HIST Historical measurement values
HMI Human-machine interface, touchscreen
ID Detector ID, detector type
IP Communication link, IP connection
MC Fire gas concentration measurement value, CO concentration value
MOP₁-MOP_{X} Individual measurement values for smoke concentration
MT₁-MT_{Y} Individual measurement values for temperature
MCO₁-MCO_{Z} Individual measurement values for CO concentration
MCP Manual fire alarm, manual call point
ML Detector line, detector bus
MO Smoke concentration measurement value
MT Temperature measurement value
NO Input pushbutton/softkey for NO decision
OG, TG, CG First threshold value
OG2, TG2, CG2 Second threshold value
OPT Smoke concentration, fire characteristic variable
RAM RAM memory
REC, Incident data record, data structure, container
REC1-RECn file
REC+ Extended incident data record, data structure, extended container file,
RING Ring buffer
T Acquisition time duration
t Time axis
t₀, t₁, t₂, Time points
t₁₁, t₁₂
TEMP Temperature, temperature measurement signal, fire characteristic variable
TIME Recording time point
TYPE Detector type
UZ Circulation time
YES Input pushbutton/softkey for YES decision
Y/N User-side input
ZAL Fire alarm on central system side
ZI Supplementary information on central system side
ZTIME Time point on central system side, system time

What is claimed is:

1. A method for recording measurement values relating to fire characteristic variable indicating a potential fire incident and detected by a fire alarm device, the method comprising:
supplying energy to a central fire alarm system with a plurality of fire alarm devices connected via a common detector line for data transmission purposes;
temporarily storing measurement values, if a current measurement value of the fire characteristic variable exceeds a respective predefined first threshold value as an indicator of a potential fire incident, as a log recorded in a data memory of the respective fire alarm device;
forming an incident data record upon completion of the recording from the respective measurement values together with header data; and
transferring an incident data record by the respective fire alarm device in a temporally distributed manner and using multiple data transmission blocks released by the central fire alarm system to the central fire alarm system.

2. The method as claimed in claim 1, wherein an average data transmission rate DRZ between a fire alarm device and the central fire alarm system is less by a multiple than an average storage data rate for storing an incident data record in the respective fire alarm device.

3. The method as claimed in claim 1, wherein:
the header data comprises file organization data, a detector ID, a recording time, a recording format, a detector type, or detector-side supplementary information relating to a detector event; and
a detector event comprises an alarm level generated independently by the respective fire alarm device, a fire alarm, or a pre-alert.

4. The method as claimed in claim 1, further comprising performing the data transmission between a fire alarm device and the central fire alarm system in circulation cycles with sequentially succeeding transmission frames for each fire alarm device;
wherein a data transmission block releasable by the central fire alarm system is provided in each case in a transmission frame for the data transmission from the respective fire alarm device to the central fire alarm system; and
a data transmission block comprises a data volume in a range of 8 bits to 96 bits.

5. The method as claimed in claim 1, wherein the maximum data transmission rate amounts to 10 kbps.

6. The method as claimed in claim 1, wherein the measurement values of the fire characteristic variable are acquired at a higher sampling rate and stored in the data memory of the respective fire alarm device if one of the respective predefined first threshold values has been exceeded.

7. The method as claimed in claim 1, wherein a respective incident data record received by the central fire alarm system is extended by at least one piece of supplementary information acquired by the central fire alarm system and temporally assignable to the respective incident data record on the central system side, wherein supplementary information on the central system side comprises a system time of the central fire alarm system and/or a fire alarm detected on the central system side and/or an alarm level detected on the central system side and/or a manual call point alarm and/or a user-side input concerning the presence of an actual fire or of a false alarm, wherein the thus extended incident data record is stored in a database of the central fire alarm system or in a database of a cloud infrastructure connected for data communication purposes to the central fire alarm system to allow further possible, where appropriate partly automated, assessment of the extended incident data records by a user in respect of the presence of an actual fire.

8. The method as claimed in claim 1, wherein the continuous acquisition of the measurement values of the fire characteristic variable in the respective fire alarm device is terminated if:
a predefined acquisition time for a respective incident data record is reached;
the free storage capacity of the data memory has been exhausted;
a fire alarm or an alarm level is generated by the respective fire alarm device;
a respective predefined second threshold value is exceeded which is greater than the associated respective first threshold value;
the respective predefined first threshold value is undershot once more; or
a STOP command from the common detector line to terminate the continuous acquisition is received by the respective fire alarm device.

9. The method as claimed in claim 1,
wherein;
a respective formed incident data record for buffering is initially stored sequentially in a buffer organized in the data memory of the respective fire alarm device; and
the incident data records stored in the buffer of the respective fire alarm device are then transmitted sequentially in the released transmission time blocks from the respective fire alarm device to the central fire alarm system.

10. The method as claimed in claim 9, wherein, after an incident data record has been stored in the buffer of a respective fire alarm device, measurement values are again acquired continuously and stored if at least one respective measurement value once again exceeds the respective predefined first threshold value as an indicator of a potential fire incident.

11. The method as claimed in claim 1, wherein:
the measurement values of the fire characteristic variable are acquired continuously by the respective fire alarm device and stored in a ring buffer organized in the data memory of the respective fire alarm device and having a predefinable circulation time;
the measurement values stored in the ring buffer are saved as historical measurement values in the data memory of the respective fire alarm device by data processing means if at least one respective measurement value of the fire characteristic variable exceeds a respective predefined first threshold value as an indicator of a potential fire incident;
the measurement values of the fire characteristic variable are further acquired continuously by the respective fire alarm device and stored; and
the respective incident data record is then formed from the saved historical measurement values, from the further continuously acquired measurement values stored in the ring buffer (RING) and from the header data.

12. The method as claimed in claim 1, wherein the measurement values of the fire characteristic variable are reduced in their data volume by means of a lossless or by means of a minimally lossy data reduction method.

13. A fire alarm device comprising:
a fire sensor to detect a respective fire characteristic variable;
a data memory; and
a control unit connected to the fire sensor and the data memory;
wherein the control unit is connected to a common detector line of a central fire alarm system for electrical power and communication;
wherein the control unit acquires measurement values of a fire characteristic variable and generates a fire alarm in the event of a fire being detected; and
the control unit stores continuously acquired measurement values of the fire characteristic variable temporarily in the data memory if at least one respective measurement value exceeds a respective predefined first threshold value;
the control unit forms an incident data record from the measurement values logged in the data memory together with header data and transfers the incident data record using data transmission blocks released by the central fire alarm system in a temporally distributed manner to the central fire alarm system.

14. The fire alarm device as claimed in claim 13, wherein:
the fire alarm device stores a respective incident data record at an average storage data rate DRM in the data memory of the fire alarm device;
the average data transmission rate DRZ between the fire alarm device and the central fire alarm system is less by a multiple than the average storage data rate.

15. The fire alarm device as claimed in claim 13, wherein:
the header data comprises file organization data, a detector ID, a recording time, a recording format, a detector type, or detector-side supplementary information relating to a detector event; and
a detector event is an alarm level generated independently by the fire alarm device, a fire alarm, or a pre-alert.

16. The fire alarm device as claimed in claim 13, wherein;
the control unit transmits the incident data record to the central fire alarm system using multiple temporally distributed data transmission blocks temporally allocated to the fire alarm device and released by the central fire alarm system; and
a data transmission block comprises a data volume in a range of 8 bits to 96 bits.

17. The fire alarm device as claimed in claim 13, wherein the control unit acquires the measurement values at a higher sampling rate after one of the respective predefined first threshold values has been exceeded.

18. The fire alarm device as claimed in claim 13, wherein the control unit terminates the continuous acquisition of the measurement values if:
a predefined acquisition time for the incident data record is reached;
the free storage capacity of the data memory has been exhausted;
a fire alarm or an alarm level is generated by the control unit;
the respective predefined second threshold value, which is greater than the associated respective first threshold value is exceeded;
the respective predefined first threshold value is undershot once more; or
a STOP command is received by the control unit from the common detector line to terminate the continuous acquisition.

19. The fire alarm device as claimed in claim 13, further comprising a buffer organized in the data memory;
wherein the control unit temporarily stores a respectively formed incident data record initially Sequentially for buffering in the buffer; and
the control unit then transfers the buffered incident data records sequentially in the released data transmission blocks to the central fire alarm system.

20. The fire alarm device as claimed in claim 13, further comprising a ring buffer organized in the data memory with a predefinable circulation time;
wherein the control unit is configured:
to acquire the measurement values continuously and to store them in the ring buffer;
to save the measurement values stored in the ring buffer as historical measurement values if a currently acquired measurement value exceeds a respective predefined first threshold value;
to acquire the measurement values further continuously and to store them in the ring buffer; and
to form the incident data record from the saved historical measurement values and from the further continuously acquired and stored measurement values together with the header data.

21. The fire alarm device as claimed in claim 13, wherein the control unit is configured to reduce the stored measurement values in their data volume by means of a computer program executed on the control unit to perform a lossless or a minimally lossy data reduction method.

22. A central fire alarm system comprising:
a common detector line;
a plurality of fire alarm devices alarm devices and/or manual call points;
a control unit which is configured to:
receive an incident data record via the detector line from the respective fire alarm devices in multiple temporally distributed data transmission blocks and
to assemble the respective incident data record by evaluating its header data piece by piece to form the respective incident data record and store it in a database.

23. The central fire alarm system as claimed in claim 22, wherein:
the control unit is configured to extend a respective assembled incident data record by at least one piece of supplementary information acquired on the central system and temporally assignable to the respective incident data record and to store it as an extended incident data record in the database;
supplementary information on the central system side comprises a system time of the central fire alarm system, a fire alarm detected on the central system side, an alarm level detected on the central system side, a manual call point alarm, and/or a user-side input concerning the presence of an actual fire or a false alarm.

24. The central fire alarm system as claimed in claim 22, wherein the control unit is configured to store a respective incident data record or a respective extended incident data record in a database of the central fire alarm system.

25. The central fire alarm system as claimed in claim 22, wherein the control unit is configured to store a respective incident data record or a respective extended incident data record in a database of a cloud infrastructure connected to the central fire alarm system for data communication purposes.

26. (canceled)
